(19) United States
(12) Patent Application Publication
(10) Pub. No.: US 2024/0191513 A1
(43) Pub. Date: Jun. 13, 2024

(54) TILE FOR THERMAL AND ACOUSTIC INSULATION AND PRODUCTION METHOD

(71) Applicants: Fabrizio MORINI, Sassuolo (IT); Filippo PERINI, Palagano (IT)

(72) Inventors: Fabrizio MORINI, Sassuolo (IT); Filippo PERINI, Palagano (IT)

(21) Appl. No.: 18/287,903

(22) PCT Filed: Apr. 22, 2022
(86) PCT No.: PCT/IB2022/000174

§ 371 Date: Oct. 23, 2023

(30) Foreign Application Priority Data
Apr. 23, 2021 (IT) 102021000007955

(51) Int. Cl. E04F 13/08; B29C 44/12; B29C 44/34; B29C 71/02; B29K 25/00; B29K 105/16; B29K 507/04; B29L 31/10

(52) U.S. Cl. CPC E04F 13/0875; B29C 44/1271; B29C 44/3415; B29C 71/02; B29K 2025/06; B29K 2105/16; B29K 2507/04; B29L 2031/104

(57) ABSTRACT

The tile for thermal and acoustic insulation has engravings (1) arranged by a diamond disc angled of about 45° along the inside part (2) of the tile (3). Said tile (3) is hung and glued to the hook (4) of the bracket (5), with the brackets (5) fixed inside each panel (6).

### FIELD OF THE INVENTION

The invention refers to a tile for indoor and/or outdoor use for building use. The invented tile has a high degree of thermal and acoustic insulation obtained with its construction.

### STATE OF THE ART

In the art coatings are known, including tiles, with thermal and acoustic insulation obtained on the base at the material used for such insulation. Walls are built with thermal and acoustic insulating, such as polystyrene and similar, onto which are placed tiles like coating. The insulating materials, however, have low stiffness, for which it is required a fixing of the tiles into the wall with metallic means. The fixing means of said tiles into the wall constitute however thermal and acoustic bridges capable of worsening the thermal-acoustic performance of the building, such as the fixing means are present on each tile and their cumulative effect leads to a loss of the performance of the insulating of the wall onto which are placed.

### SUMMARY OF THE INVENTION

Aim of the present invention is a fixing system for tiles, made of porcelain stoneware, stone, wood, resinous compounds, laminates, agglomerates, aluminum and similar that permits to avoid the cited disadvantages not having thermal and acoustic bridges that are formed in the fixing of the tiles into the wall, even if equipped with an insulated panel. The fixing system according to the invention, moreover, permits the use of insulating panels of greater thickness than what was built in the art prior to the invention. The invention than permits an easy practical and quick assembly at the walls to be thermally and acoustically insulated. The tile for thermal and sound insulation according the invention is coupled with an EPS (sintered expanded polystyrene) insulating panel added with graphite of other insulating material (for example pressed cork) obtained by a shell mold and with the steel brackets placed inside the mold suitable shaped to be assembled with a bayonet fitting in the porcelain stoneware tile, thick from six to nine millimeters, with engravings onto the inside face of the tile for the connections with the brackets incorporated into the panel. The inside face of the tile is, moreover, provided of glue for the gluing to the EPS insulating panel. Having placed the steel brackets in the sheel mold, within which the formation of the panel taken place, ie the expansion of the polystyrene and and the subsequent sintering, so gives the advantage to avoid thermal and acoustic bridges. These and other aims and advantages of the invention are more evident in the following detailed description of a preferred embodiment but not exclusive, with reference to the attached drawings, wherein the invention is illustrated in a merely indicative, so not limiting, way.

### BRIEF DESCRIPTION OF THE DRAWINGS

FIG. 1 is perspective view of the tile for thermal and acoustic insulation with EPS panel and brackets fir fixing at the wall of the tile—FIG. 2 is perspective view of a bracket.

FIG. 3 is lateral view of the tile connected to a EPS panel.

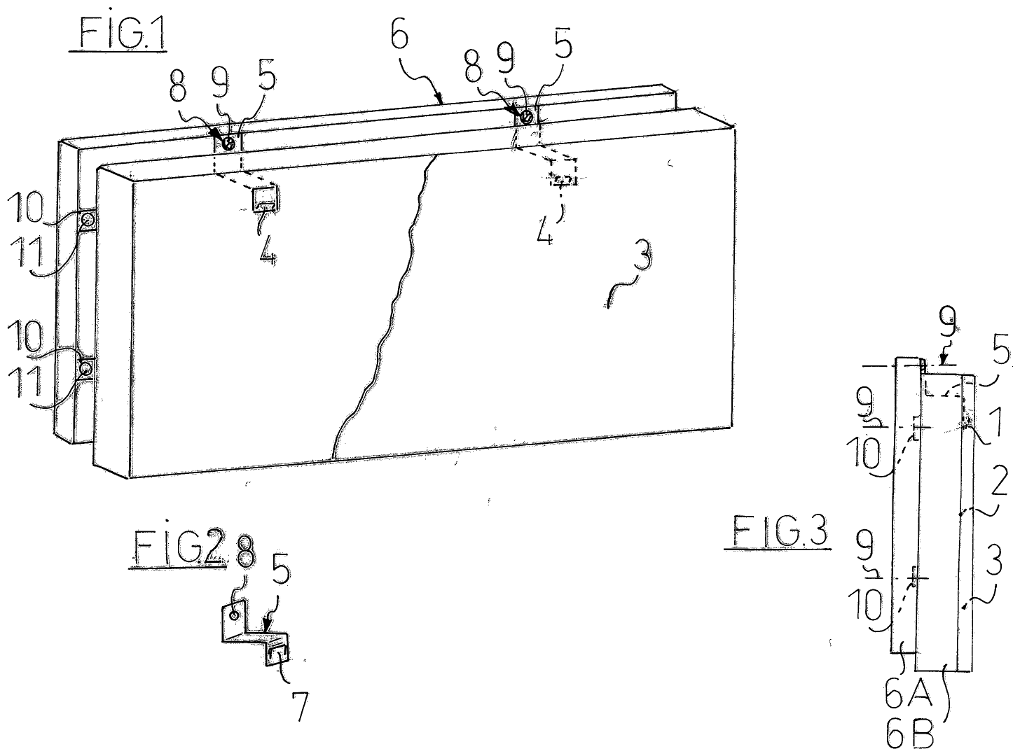

### DETAILED DESCRIPTION

The thermal and acoustic insulation tile has engravings 1 arranged by a diamond disc angled of about 450 along the inside part 2 of the tile 3. Said tile 3 can be made of porcelain stoneware, preferably of thickness included between six and nine millimeters. In other embodiments the tile can be made of other materials such as stone, resinous compounds, agglomerates and other coatings in use in construction. The tile 3 is, then, hung and glued to the hook 4 of the bracket 5 and to all the outside surface of the panel 6. Are expected at least two support brackets 5 to the panel 6. The hook 4 is preferably a hook with flap 7 inclined at 45° upwards for interlocking with the engraving 1 and the support of the tile 3. Then the hook 4 provides a hole 8 into which the fixing means 9 are placed for the position onto the wall of the tile 3. The glue used between the inside part of the tile 3 and the panel 6 is, for example MS-Polymer glue. The panel 6 is arranged on staggered floors 6A and 6B and provides long the sides of the floor 6A metal plates 10 with central hole 11 for the insertion of further fixing means, in addition to those place into the holes 8 of the hooks 4 for the positioning onto the wall of the invention. In the assembling of more panels 6 so there are not metallic parts that directly connected the external environment at the tile 3 with the wall onto which is placed. The fixing means 9 to the wall can be of different kind, as for example Keil fixing system of Fisher or rawplugs. In other realization version the thermal and acoustic insulating tile is to be placed onto the wall by fixing means 9, such as for example the Keil fixing system of the Fisher, placed in holes 11 of the metal plates 10 in the sides of the floor 6A. The brackets 5 are fixed inside each panel 6 with a production method according the following steps: a—putting of the brackets 5 inside a shell mold; b—insertion inside the closed shell mold of polystyrene added with graphite; c—expansion phase of the polystyrene inside the mold; d—sintering phase of the polystyrene added with the graphite; e—cooling and extraction by opening of the shell mold. With this method so are arranged brackets 5 inside the EPS panel 6 avoiding metallic parts in connection with the external environment and with the wall. The same method can be arranged for the production of panel made of pressed cook, The invented device is open to a lot of modifications and variations, all part of the inventive object. Every detail can be changed with technically equivalent alternative without exiting to the protection field of the enclosed claims.

1. Tile for thermal and acoustic insulation comprising engravings (1) arranged by a diamond disc angled of about 45° along the inside part (2) of the tile (3) characterized in that the tile (3) is hung and glued to the hook (4) of the bracket (5), with the brackets (5) fixed inside each panel (6), with a production method according the following steps: a—putting of the brackets (5) inside the shell mold; b—insertion inside the closed shell mold of polystyrene added with graphite; c—expansion phase of the polystyrene inside the mold; d—sintering phase of the polystyrene added with graphite; e—cooling and extraction by opening of the shell mold, wherein the tile for thermal and acoustic insulation is coupled with an EPS insulating panel (6) added with graphite.

2. Tile for thermal and acoustic insulation, according to claim 1, characterized in that the panel (6) is arranged on staggered floors (6A, 6B).

3. Tile for thermal and acoustic insulation, according to claims 1 and 2, characterized in that it presents long the sides of the floor (6A), metal plates (10) with central holes (11).

4. Tile for thermal and acoustic insulation, according to claims 1, 2 and 3, characterized in that in the holes (8, 11) fixing means (9) are inserted, for the connection to the wall of the tile (3).
